(19) United States
(12) Patent Application Publication
(10) Pub. No.: US 2006/0248586 A1
(43) Pub. Date: Nov. 2, 2006

(54) Methods, systems, and computer program products for surveillance monitoring in a communication network based on a national surveillance database

(75) Inventors: Robert J. Delaney, Raleigh, NC (US); Todd Eichler, Wake Forest, NC (US); Peter J. Marsico, Chapel Hill, NC (US)

Correspondence Address: JENKINS, WILSON, TAYLOR & HUNT, P. A., 3100 TOWER BLVD, SUITE 1200, DURHAM, NC, 27707, US

(73) Assignee: Tekelec

(21) Appl. No.: 11/116,089

(22) Filed: Apr. 27, 2005

(51) Int. Cl. G06F 12/14

(52) U.S. Cl. 726/22

(57) ABSTRACT

Methods, systems, and computer program products are disclosed for providing surveillance monitoring in a communication network based on a national surveillance database. Communication-related information is received from a national surveillance database that includes communication-related information relating to individuals under surveillance. The received communication-related information is used to screen signaling messages relating to communications associated with the individuals.

### TECHNICAL FIELD

The subject matter described herein relates to communication monitoring. More particularly, the subject matter described herein relates to providing surveillance monitoring in a communication network based on a national surveillance database.

### BACKGROUND

Security has become an ever-growing concern in today's society. As security threats continue to increase, the perpetrators of crimes are enjoying the benefit of increased mobility and the ability to communicate anonymously using modern communication technologies. In order to better combat such security threats, it would be helpful to have the infrastructure and functionality in place to monitor the use of communication resources, such as the public switched telephone network (PSTN), by target individuals based on information collected and stored on a national level. That is, it would be helpful to law enforcement if a national master list of individuals under surveillance that may be administered, for example, by law enforcement was available to be used to monitor subscriber communication attempts/communications in a communication network.

For example, call patterns and call-associated information, such as called party identification information and calling party identification information, for target individuals under surveillance may be monitored. Such information would prove helpful to law enforcement while limiting the exposure of law enforcement personnel to dangerous situations. In addition, it would be desirable that such information be provided to communication service providers real time or near real time, so that law enforcement can respond swiftly to developing events.

Currently, such a national surveillance database does not exist. Another problem with surveillance in modern communication networks is that subscribers have multiple communication identities. For example, a single subscriber may have several directory numbers, correspond to home, work, and mobile phones. In addition, with the advent of IP telephony, subscribers may also have a IP telephony identities, such as session initiation protocol (SIP) uniform resource indicators (URIs). Even if a national surveillance database existed there would still be a need to correlate the identities of a subscriber for surveillance purposes.

Accordingly, there exists a need for methods, systems, and computer program products for providing surveillance monitoring in a communication network based on a national surveillance database and for correlating identities of a subscriber under surveillance.

### SUMMARY

In one aspect of the subject matter disclosed herein, a method is disclosed for providing surveillance monitoring in a communication network based on a national surveillance database. The method includes receiving, from a national surveillance database that includes communication-related information relating to individuals under surveillance, communication-related information relating to the individuals. The received communication-related information is used to screen signaling messages relating to communications associated with the individuals.

In another aspect of the subject matter disclosed herein, a system is disclosed for providing surveillance monitoring in a communication network based on a national surveillance database. The system includes a communications node that includes a surveillance database function for receiving, from a national surveillance database that includes communication-related information relating to individuals under surveillance, communication-related information relating to the individuals and for storing the communication-related information. The communication node also includes a surveillance screening function for using the received communication-related information to screen signaling messages relating to communications associated with the individuals.

In another aspect of the subject matter disclosed herein, a computer program product is disclosed. The computer program product includes computer executable instructions embodied in a computer-readable medium. The computer executable instructions are for performing steps including receiving, from a national surveillance database that includes communication-related information relating to individuals under surveillance, communication-related information relating to the individuals and using the received communication-related information to screen signaling messages relating to communications associated with the individuals.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating a system for providing surveillance monitoring in a communication network based on a national surveillance database according to an aspect of the subject matter disclosed herein;

FIG. 2 is a block diagram illustrating a system for providing surveillance monitoring in a communication network based on a national surveillance database according to another aspect of the subject matter disclosed herein;

FIG. 3 is a block diagram illustrating a system for providing surveillance monitoring in a communication network based on a national surveillance database according to an aspect of the subject matter disclosed herein;

FIG. 4 is a flow diagram illustrating a method for providing surveillance monitoring in a communication network based on a national surveillance database according to an aspect of the subject matter described herein; and

FIG. 5 is a flow diagram illustrating a method for providing surveillance monitoring in a communication network based on a national surveillance database according to another aspect of the subject matter described herein.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

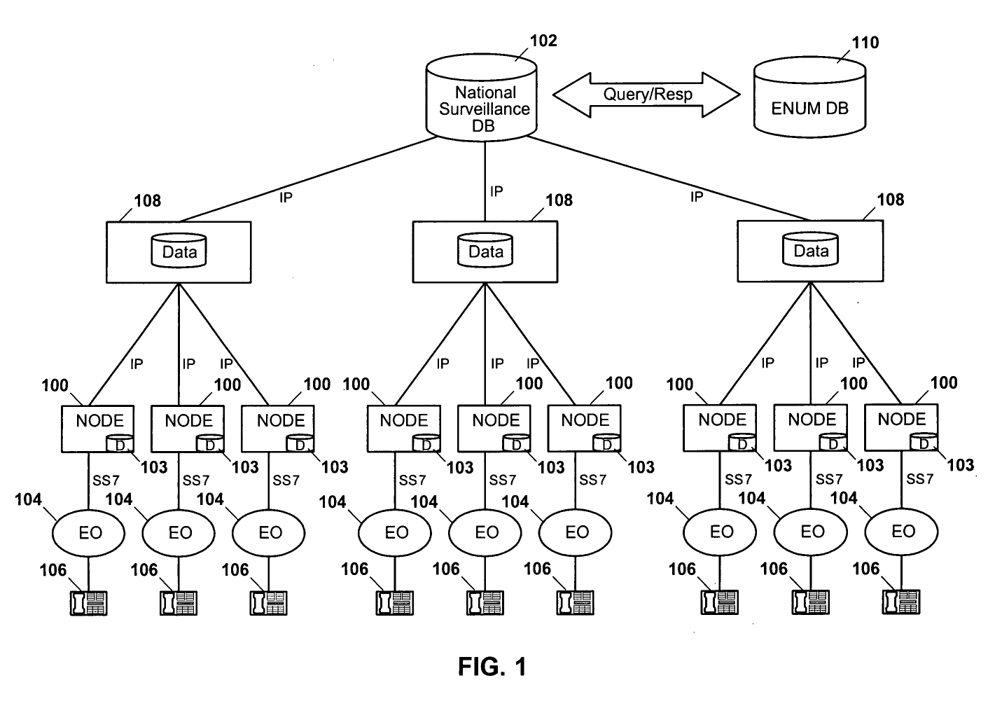

FIG. 1 is a block diagram illustrating a system for providing surveillance monitoring in a communication network based on a national surveillance database according to an aspect of the subject matter disclosed herein. In FIG. 1, the system includes one or more communications nodes 100 that receive communication-related information relating to individuals under surveillance from a national surveillance database 102. Communication nodes 100 use the received communication-related information to screen signaling messages relating to communications associated with the individuals, as discussed further below. Some or all of the received communication-related information may be stored locally on communication node 100 in a local database 103. The signaling messages may be received, for example, from an end office 104 in a public switched telephone network (PSTN) according to signaling system 7 (SS7) protocol. End office 104 is connected to one or more telephones 106 and facilitates calls over the PSTN.

Each communication node 100 can be an SS7 signal transfer point (STP), an SS7-Internet protocol (IP) signaling gateway, SS7 service control point, a router, a session initiation protocol (SIP) proxy node, an IP multimedia subsystem (IMS) node, a media gateway controller (MGC), a softswitch, a media gateway (MG), a mobile switching center (MSC), a home location register (HLR), an equipment identity register (EIR) node, an authentication center (AuC), a radio access network (RAN) node, or any other communication node.

According to one aspect, national surveillance database 102 includes communication-related information for individuals under surveillance. The communication-related information is downloaded to each communication node 100 using any known communication method. For example, the communication- related information may be provided to each communication node 100 over an IP network via an IP link, either directly or indirectly. For example, according to one implementation, the national surveillance database distributes the communication-related information to one or more regional databases 108, which provide the communication-related information to communication nodes 100. The communication-related information in regional databases 108 may be a copy of the information contained in a national surveillance database 102 or may be a subset of the information that corresponds to a specific region. For example, a regional database may include communication-related information that corresponds to a specific service provider or to a specific region.

According to another aspect, an electronic numbering (ENUM) database 110 provides additional subscriber identities that correspond to a subscriber once one subscriber ID is provided. ENUM database 110 may access a domain name system (DNS) server that includes one or more additional subscriber identifiers that correspond to a subscriber ID. For example, the subscriber ID may be a subscriber's telephone number and the corresponding subscriber identifiers may be one or more SIP URIs. ENUM database generally correlates an E.164 formatted telephone number such as a home number, pager number, mobile number, or fax number, or dialable short code identifier to one or more SIP URIs that can identify an IP address, an e-mail address, a network alias identifier (e.g., a screen name), and other like information associated with the subscriber. Other information may be contained in ENUM database 110 as well, such as phone numbers.

National surveillance database 102 may query ENUM database 110 to obtain the corresponding subscriber identifiers associated with a subscriber identifier in a national surveillance database 102. For example, when a surveillance authority places a subscriber ID, such as phone number “9193803814”, under surveillance, a surveillance application in national surveillance database 102 can query ENUM database 110 using the “9193803814” identifier to obtain all other identifiers to which the number has been associated.

National surveillance database 102 may query ENUM database 110 periodically for updates or as information is needed. In one aspect, ENUM database 110 is adapted to receive a subscription request that is associated with a “watched” subscriber ID and to report to the national surveillance database all ENUM information corresponding to the watched subscriber ID. ENUM database 110 may also be adapted to report all changes to ENUM information.

In one implementation, ENUM database 110 is adapted to respond to queries by national surveillance database 102 with a set of one or more naming authority pointer (NAPTR) records, which contain one or more uniform resource identifier (URI) values associated with the subscriber identifier. The phone number “9193803814” may be transformed into a hostname by reversing the numbers, separating them with dots, and adding an e164.arpa suffix, to yield 4.1.8.3.0.8.3.9.1.9.e164.arpa. A DNS server can then be used to look up Internet addresses for services such as SIP telephony. NAPTR records may be used to translate E.164 addresses to SIP addresses. An exemplary NAPTR record is shown below:

$ORIGIN 2.4.2.4.5.5.5.1.e164.arpa.

IN NAPTR 100 10 “u” “sip+E2U” “!ˆ.*$!sip:phoneme@example.net!”.

The above example specifies that sip:phoneme@example.net is the address for the “sip+E2U” service. The expression provides the ability to map corresponding SIP addresses to subscribers.

The surveillance application receives the NAPTR records and incorporates the URI values into the surveillance database. Alternatively, or in addition, ENUM database 110 may respond to queries by regional databases 108.

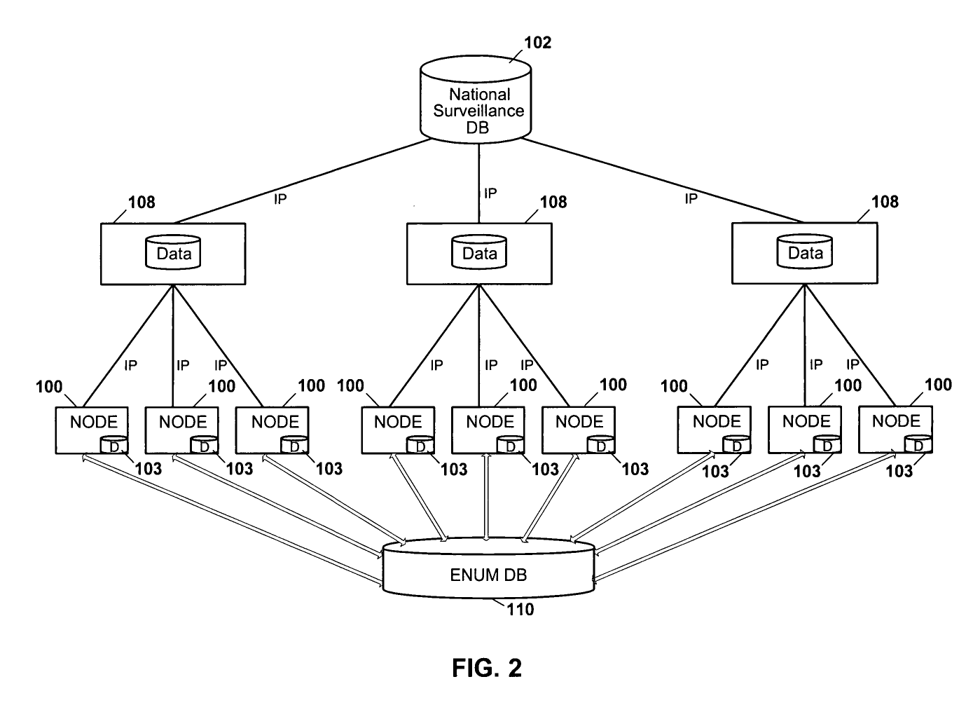

According to another aspect of the subject matter disclosed herein, communication nodes 100 are adapted to query ENUM database 110 for ENUM information. FIG. 2 is a block diagram illustrating a system for providing surveillance monitoring in a communication network based on a national surveillance database according to another aspect of the subject matter disclosed herein. In FIG. 2, communication nodes 100 are adapted to query ENUM database 110 to receive ENUM information corresponding to the communication-related information received from national surveillance database 102. For example, communication node 100 may send a request message to ENUM database 110 that includes a subscriber ID, such as a phone number. ENUM database 110 may send a response message that includes corresponding subscriber identifiers, such as a SIP URI.

Whether the information is provided directly to communication node 100 by ENUM database 110 or via national surveillance database 102, communication node 100 may use the received ENUM information to screen signaling messages relating to communications associated with the individuals.

National surveillance database 102 preferably includes a master list of individuals under surveillance, with regional databases 108 and/or communication nodes 100 being updated to match corresponding information in national surveillance database 102. For example, updated communication-related information may be provided to the regional databases and/or communication nodes as a periodic update. Communication node 100 may include a data audit function to confirm that the communication-related information in communication node 100 is current and matches the corresponding communication-related permission in the national surveillance database 102 and/or regional databases 108.

The communication-related information may also be encrypted and/or transferred to communication node 100 using a secure connection. For example, a secure connection may be established by using one or more security protocols for transferring the communication-related information over an IP network. Examples of security protocols include Internet protocol security protocol (IPSec), secure sockets layer (SSL), private communications technology (PCT), hypertext transport protocol secure (HTTPS), and secure hypertext transport protocol (SHTTP).

National surveillance database 102 is preferably administered by a law enforcement agency or other authority to provide secure centralized control of the communication-related information. According to one implementation, the communication-related information is not directly accessible or otherwise viewable at communication node 100 for added security.

Exemplary communication-related information that may be received by communication node 100 from national surveillance database 108 is illustrated in Table 1. Table 1 includes a subscriber identifier, corresponding ENUM information, a communication mode identifier, a surveillance action instruction, a surveillance authority contact identifier, a surveillance authority contact mode identifier, a surveillance tap identifier, a surveillance start time indicator, and a surveillance end time indicator. Table 1 may also include other information not shown, such as a text-to-voice conversion preference and a language translation preference.

TABLE 1
Exemplary Communication-Related Information

| | | | | Surveillance | Surveillance | | | |
|---|---|---|---|---|---|---|---|---|
| | Associated | | | Authority | Authority | Surveillance | | |
| Subscriber | ENUM | Communication | Surveillance | Contact | Contact | Tap | Start | End |
| ID | Information | Mode | Action | ID | Mode | ID/LRN | Date | Date |
| 9192536694 | — | Voice | Notify | fraud@ | e-mail | — | May 10, | Jun. 10, |
| | | | | FBI.gov | | | 2005 | 2005 |
| 9195669898 | 9195668422 | Voice | Notify, | 9195551234 | SMS | — | Apr. 12, | May 18, |
| | | | CDR | | | | 2005 | 2005 |
| 9195658878 | Bob@ | Msg | Msg Copy | 9195552325 | VoiceMail | — | May 11, | Aug. 11, |
| | crime.org | | | | | | 2005 | 2005 |
| 9195668474 | | Voice | Notify, | Smith@FBI.gov | IM | 9195550000 | Apr. 10, | none |
| | | | Redirect | | | | 2005 | |

The subscriber identifier may include, for example, a mobile subscriber identifier (e.g., MSISDN, IMSI, MIN), an E.164 formatted telephone number, a dialable short code identifier, an IP address, an electronic mail address, a network alias identifier, or a SIP URI.

The corresponding ENUM-based information may similarly include, for example, a mobile subscriber identifier, an E.164 formatted telephone number, a dialable short code identifier, an IP address, an electronic mail address, a network alias identifier, and/or a SIP URI. The ENUM-based information corresponds to the subscriber ID and is originated by ENUM database 110.

The communication mode identifier is used to specify a particular mode or communication medium. The communication mode identifier may include, for example, a voice service mode identifier, a short message service mode identifier, multimedia message service mode identifier, instant message service mode identifier, and/or an electronic mail service mode identifier.

The surveillance action instruction specifies actions that are to be taken if the associated subscriber is involved in a call or a call setup attempt. The surveillance action instruction may include, for example, providing a notification message to a surveillance authority, generating a log entry in surveillance log, generating a call detail record (CDR), redirecting the call, and/or blocking the call.

The surveillance authority contact identifier may be used for sending notification messages or other required communications with a surveillance authority. The surveillance authority contact identifier may include, for example, a mobile subscriber identifier, a plain old telephone service telephone number, a dialable short code identifier, an IP address, an electronic mail address, a network alias identifier, or a SIP URI.

The surveillance authority contact mode identifier may be used to specify a particular mode of contact with a designated surveillance authority. The surveillance authority contact mode identifier may include, for example, electronic mail, instant message, short message service, multimedia message service, voice, and voicemail.

The surveillance tap identifier identifies a second communication node to route a call to for monitoring. A surveillance tap identifier may be included with respect to calls that require a real-time tap of the bearer stream, where a bearer stream may include audio, video, or other streaming data (e.g., WEB browsing session). The surveillance tap identifier may be used to identify a particular node in the network through which a watched call is to be forcibly routed/re-routed. Examples of a surveillance tap ID may include an IP address, an SS7 point code address, or a network alias routing address, such as an SS7 location routing number. The surveillance tap ID may, for instance, identify a law enforcement equipped tandem office, or media gateway.

The surveillance start date and end date may include date and/or time information indicating when surveillance should start and end.

Additional parameters not shown in exemplary Table 1 include a text-to-voice conversion preference and a language translation preference, The text-to-voice conversion preference may be specified with respect to the surveillance of messaging service messages (e.g., SMS, IM, MMS). The text-to-voice conversion preference identifies whether to translate an intercepted text message from text to voice prior to communicating the message contents to a surveillance authority.

The language translation preference identifies whether to translate an intercepted text message into a language required by a surveillance authority. More particularly, with respect to international applications, it may be useful for the database to associate a language preference with a surveillance authority, such that an intercepted text message may be translated into a language required by a surveillance authority. For example, a text message that is written in German may be translated into French, so that a French surveillance authority may quickly and easily review/interpret the contents of the intercepted German text message. The same language translation preference may be specified with respect to text-to-voice conversions.

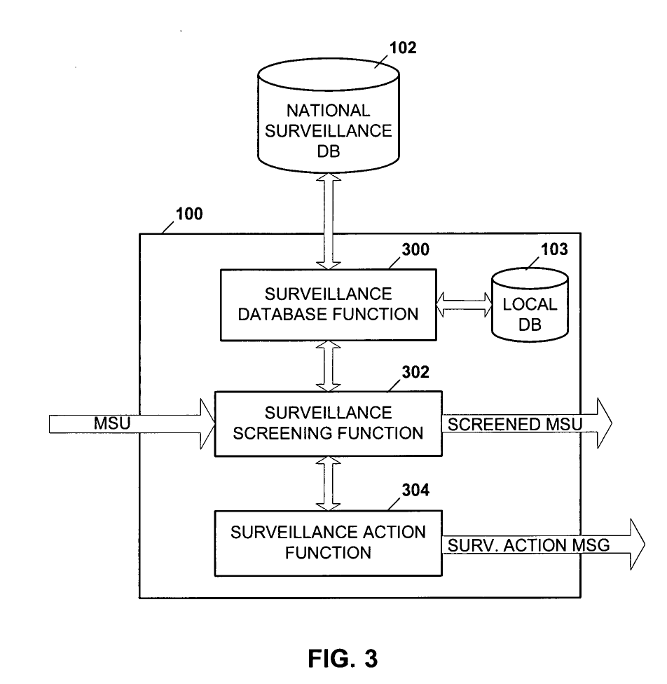

FIG. 3 is a block diagram illustrating a system for providing surveillance monitoring in a communication network based on a national surveillance database according to one aspect of the subject matter disclosed herein. The system includes communications node 100. Communication node 100 includes a surveillance database function 300, a surveillance screening function 302, and a surveillance action function 304. Surveillance database function 300 receives communication-related information from national surveillance database 102 relating to communications associated with individuals under surveillance and stores the communication-related information in local database 103. The communication-related information may include ENUM information either from national surveillance database 102 or from ENUM database 110, as discussed above.

Surveillance screening function 302 uses the received communication-related information to screen signaling messages, such as SS7 message signaling units (MSUs) relating to communications associated with the individuals. Surveillance screening function screens signaling messages to determine, for example, whether a called party and/or a calling party associated with the signaling message corresponds to a subscriber ID included in the communication-related information. The signaling messages that may be screened include, for example, SS7 integrated services user part (ISUP), SS7 signaling connection control part (SCCP), transaction capabilities application part (TCAP), signaling transport (SIGTRAN) message transfer part 3 user adaptation layer (M3UA), SIGTRAN SCCP user adaptation layer (SUA), SIP, and H.323 signaling messages. Surveillance screening function 302 communicates with surveillance database function 300 to determine if the called and/or calling party associated with a screened signaling message is in local database 103.

Surveillance action function 304 performs a surveillance action in response to surveillance screening function 302 to determine whether the called party and/or the calling party associated With the screened signaling message corresponds to a subscriber identifier included in the communication-related information. For example, surveillance action function 304 may provide a notification message to a surveillance authority, generate a log entry in surveillance log, generate a call detail record (CDR), redirect a call associated with the screen signaling message, and/or block a call associated with the screen signaling message. Surveillance action function 304 may send a surveillance action message to another network entity to carry out the surveillance action or may perform the surveillance action at communication node 100.

The subject matter described herein is not limited to performing surveillance screening using functions associated with a communication node. In an alternative implementation, some or all of the screening functions illustrated in FIG. 3 may be located on elements of a network data collection system that is separate from or partially separate from communication node 100. One example of a commercially available network data collection platform suitable for implementing the subject matter described herein is the Sentinel™ system available from Tekelec of Calabasas Calif. Briefly, the Sentinel™ system includes message copy functions located internal to a communication node, such as a signal transfer point. The message copy functions copy signaling messages and forward the signaling message copies to a data collection platform. In addition, the Sentinel™ system may include link monitoring probes that non-intrusively copy signaling messages from signaling links external to the communication node. The probes also forward the forward the signaling message copies to the data collection platform. The network data collection platform store copies of the signaling messages and forward the message copies to regional message copying site collectors. The site collectors forward messages that meet predetermined filter criteria to a data gateway server. According to an exemplary implementation of the subject matter described herein, surveillance database function 300, surveillance screening function 302, surveillance action function 304, and local database 103 may be located on the data gateway server.

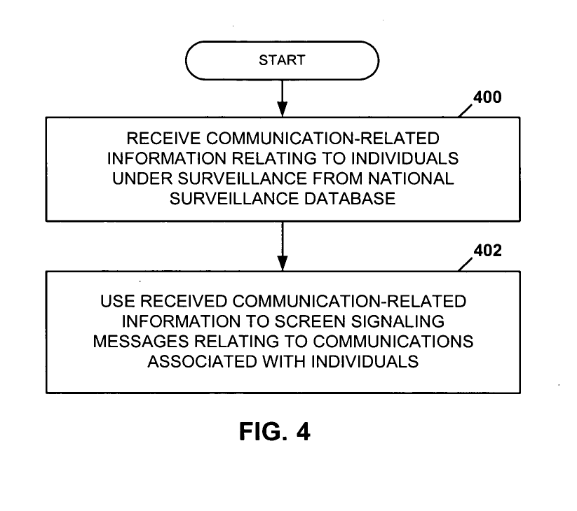

FIG. 4 is a flow diagram illustrating a method for providing surveillance monitoring in a communication network based on a national surveillance database according to an aspect of the subject matter described herein. In step 400, communication-related information relating to individuals under surveillance is received from national surveillance database 102. In step 402, the received communication-related information is used to screen signaling messages relating to communications associated with the individuals.

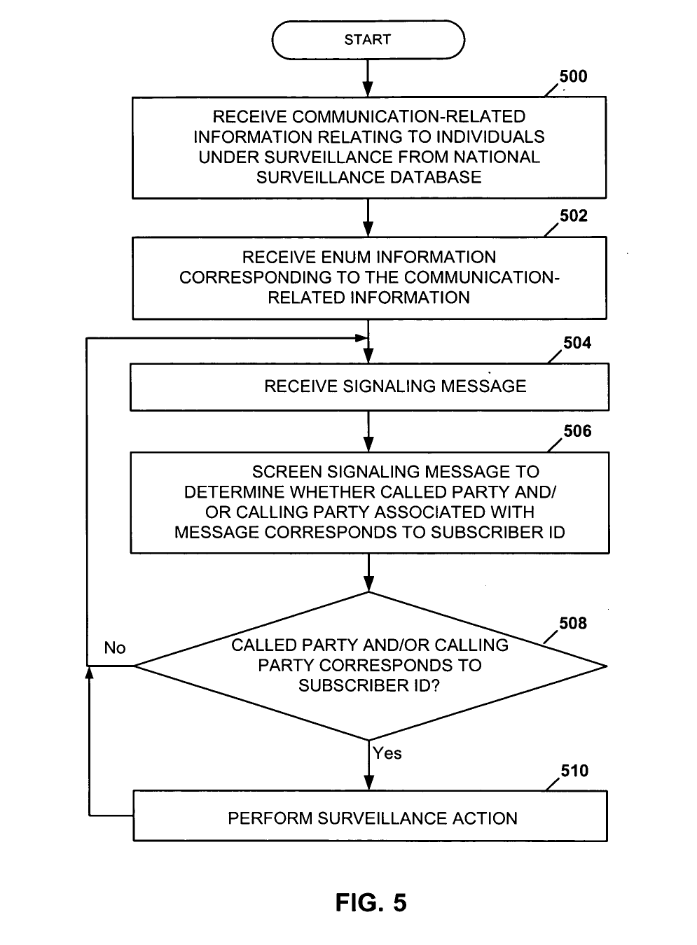

FIG. 5 is a flow diagram illustrating a method for providing surveillance monitoring in a communication network based on a national surveillance database according to another aspect of the subject matter described herein. In step 500, communication-related information relating to individuals under surveillance is received from national surveillance database 102. As discussed above, the information may be received directly or via regional surveillance database 108. In step 502, ENUM information corresponding to the communication-related information is received. The corresponding ENUM information may be received from national surveillance database 102, regional surveillance database 108, or directly from ENUM database 110, as described above. A signaling message is received in step 504. The signaling message is screened to determine whether called party and/or calling party associated with message corresponds to a subscriber ID in the communication-related information in step 506. In response to determining that a called party and/or calling party associated with the message corresponds to the subscriber ID in step 508, a surveillance action is performed in step 510.

As discussed above, surveillance actions include providing a notification message to a surveillance authority, generating a log entry in surveillance log, generating a call detail record (CDR), redirecting a call associated with the screen signaling message, and blocking a call associated with the screen signaling message. In response to determining that a called party and/or calling party associated with the message corresponds to the subscriber ID in step 508, the message is processed normally. In either case, the next message is received and processed accordingly.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing surveillance monitoring in a communication network based on a national surveillance database, the method comprising:
(a) receiving, from a national surveillance database that includes communication-related information relating to individuals under surveillance, communication-related information relating to the individuals; and
(b) using the received communication-related information to screen signaling messages relating to communications associated with the individuals.

2. The method of claim 1 wherein receiving communication-related information relating to the individuals includes receiving the communication-related information from the national surveillance database via a regional surveillance database.

3. The method of claim 1 wherein receiving communication-related information relating to the individuals includes receiving encrypted communication-related information.

4. The method of claim 1 wherein receiving communication-related information relating to the individuals includes receiving the communication-related information over a secure connection.

5. The method of claim 1 wherein receiving communication-related information relating to the individuals includes periodically receiving communication-related information updates.

6. The method of claim 1 wherein receiving communication-related information relating to the individuals includes receiving at least one of a subscriber identifier, corresponding electronic numbering (ENUM) based information, a communication mode identifier, a surveillance action instruction, a surveillance authority contact identifier, a surveillance authority contact mode identifier, a text-to-voice conversion preference, a language translation preference, a surveillance tap identifier, a surveillance start indicator, and a surveillance end indicator.

7. The method of claim 6 wherein the subscriber identifier includes at least one of a mobile subscriber identifier, an E.164 formatted telephone number, a dialable short code identifier, an IP address, an electronic mail address, a network alias identifier, and a SIP URI.

8. The method of claim 6 wherein the corresponding ENUM-based information includes at least one of a mobile subscriber identifier, an E.164 formatted telephone number, a dialable short code identifier, an IP address, an electronic mail address, a network alias identifier, and a SIP URI, and is originated by an ENUM database.

9. The method of claim 6 wherein the communication mode identifier includes at least one of a voice service mode identifier and a messaging service mode identifier, a short message service mode identifier, multimedia message service mode identifier, instant message service mode identifier, and an electronic mail service mode identifier.

10. The method of claim 6 wherein the surveillance action instruction includes at least one of provide a notification message to a surveillance authority, generate a log entry in surveillance log, generate a call detail record (CDR), redirect call, and block call.

11. The method of claim 6 wherein the surveillance authority contact identifier is at least one of a mobile subscriber identifier, a plain old telephone service telephone number, a dialable short code identifier, an IP address, an electronic mail address, a network alias identifier, and a SIP uniform resource indicator (URI).

12. The method of claim 6 wherein the surveillance authority contact mode identifier is at least one of electronic mail, instant message, short message service, multimedia message service, voice, and voicemail.

13. The method of claim 6 wherein the text-to-voice conversion preference identifies whether to translate an intercepted text message from text to voice prior to communicating the message contents to a surveillance authority.

14. The method of claim 6 wherein the language translation preference identifies whether to translate an intercepted text message into a language required by a surveillance authority.

15. The method of claim 6 wherein the surveillance tap identifier identifies a second communication node to route a call to for monitoring.

16. The method of claim 1 wherein using the received communication-related information to screen signaling messages relating to communications associated with the individuals includes screening a signaling message to determine whether at least one of a called party and a calling party associated with the message corresponds to a subscriber identifier included in the communication-related information.

17. The method of claim 16 comprising performing a surveillance action in response to determining that at least one of the called party and the calling party associated with the screened signaling message corresponds to the subscriber identifier included in the communication-related information

18. The method of claim 17 wherein performing a surveillance action includes at least one of providing a notification message to a surveillance authority, generating a log entry in surveillance log, generating a call detail record (CDR), redirecting a call associated with the screen signaling message, and blocking a call associated with the screen signaling message.

19. The method of claim 1 wherein performing steps (a) and (b) includes performing steps (a) and (b) at one of a signaling system 7 (SS7) signal transfer point, an SS7-Internet protocol (IP) signaling gateway, SS7 service control point, a router, a session initiation protocol proxy node, an IP multimedia subsystem node, a media gateway controller, a softswitch, a media gateway, a mobile switching center, a home location register, an equipment identity register node, an authentication center, a radio access network node, and a network data collection system.

20. The method of claim 1 comprising providing ENUM-database-originated information to the national surveillance database, the ENUM information including at least one additional subscriber identifier corresponding to a subscriber ID in the communication-related information, wherein the ENUM information is included in the received communication-related information.

21. The method of claim 1 comprising:
(a) querying an ENUM database for ENUM information including at least one additional subscriber identifier corresponding to a subscriber ID in the communication-related information;
(b) receiving the ENUM information; and
(c) using the received ENUM information to screen signaling messages relating to communications associated with the individuals.

22. The method of claim 21 wherein the ENUM information includes naming authority pointer (NAPTR) information.

23. A computer program product comprising computer executable instructions embodied in a computer-readable medium for performing steps comprising:
(a) receiving, from a national surveillance database that includes communication-related information relating to individuals under surveillance, communication-related information relating to the individuals; and
(b) using the received communication-related information to screen signaling messages relating to communications associated with the individuals.

24. A system for providing surveillance monitoring in a communication network based on a national surveillance database, the system comprising:
(a) a surveillance database function for receiving, from a national surveillance database that includes communication-related information relating to individuals under surveillance, communication-related information relating to the individuals and for storing the communication-related information; and
(b) a surveillance screening function for using the received communication-related information to screen signaling messages relating to communications associated with the individuals.

25. The system of claim 24 comprising at least one regional surveillance database for receiving communication-related information relating to the individuals from the national surveillance database and providing the communication-related information.

26. The system of claim 24 wherein the surveillance database function is adapted to receive encrypted communication-related information.

27. The system of claim 24 wherein the surveillance database function is adapted to establish a secure connection for receiving the communication-related information.

28. The system of claim 24 wherein the surveillance database function is adapted to periodically receive communication-related information updates.

29. The system of claim 24 wherein the surveillance database function is adapted to receive at least one of a subscriber identifier, corresponding ENUM-based information, a communication mode identifier, a surveillance action instruction, a surveillance authority contact identifier, a surveillance authority contact mode identifier, a text-to-voice conversion preference, a language translation preference, a surveillance tap identifier, a surveillance start indicator, and a surveillance end indicator.

30. The system of claim 29 wherein the subscriber identifier includes at least one of a mobile subscriber identifier, an E.164 formatted telephone number, a dialable short code identifier, an IP address, an electronic mail address, a network alias identifier, and a SIP URI.

31. The system of claim 29 wherein the corresponding ENUM-based information includes at least one of a mobile subscriber identifier, an E.164 formatted telephone number, a dialable short code identifier, an IP address, an electronic mail address, a network alias identifier, and a SIP URI, and is originated by an ENUM database.

32. The system of claim 29 wherein the communication mode identifier includes at least one of a voice service mode identifier and a messaging service mode identifier, a short message service mode identifier, multimedia message service mode identifier, instant message service mode identifier, and an electronic mail service mode identifier.

33. The system of claim 29 wherein the surveillance action instruction includes at least one of provide a notification message to a surveillance authority, generate a log entry in surveillance log, generate a call detail record (CDR), redirect call, and block call.

34. The system of claim 29 wherein the surveillance authority contact identifier includes at least one of a mobile subscriber identifier, a plain old telephone service telephone number, a dialable short code identifier, an IP address, an electronic mail address, a network alias identifier, and a SIP URI.

35. The system of claim 29 wherein the surveillance authority contact mode identifier includes at least one of electronic mail, instant message, short message service, multimedia message service, voice, and voicemail.

36. The system of claim 29 wherein the text-to-voice conversion preference identifies whether to translate an intercepted text message from text to voice prior to communicating the message contents to a surveillance authority.

37. The system of claim 29 wherein the language translation preference identifies whether to translate an intercepted text message into a language required by a surveillance authority.

38. The system of claim 29 wherein the surveillance tap identifier identifies a second communication node to route a call to for monitoring.

39. The system of claim 24 wherein the surveillance screening function screens signaling messages relating to communications associated with the individuals to determine whether at least one of a called party and a calling party associated with the message corresponds to a subscriber identifier included in the communication-related information.

40. The system of claim 39 comprising a surveillance action function for performing a surveillance action in response to the surveillance screening function determining that at least one of the called party and the calling party associated with the screened signaling message corresponds to the subscriber identifier included in the communication-related information.

41. The system of claim 40 wherein, in performing the surveillance action, the surveillance action function performs at least one of providing a notification message to a surveillance authority, generating a log entry in surveillance log, generating a call detail record (CDR), redirecting a call associated with the screen signaling message, and blocking a call associated with the screen signaling message.

42. The system of claim 24 wherein the surveillance database function and the surveillance screening function are components of one of a signaling system 7 (SS7) signal transfer point, an SS7-Internet protocol (IP) signaling gateway, SS7 service control point, a router, a session initiation protocol proxy node, an IP multimedia subsystem node; a media gateway controller, a softswitch, a media gateway, a mobile switching center, a home location register, an equipment identity register node, an authentication center, a radio access network node, and a network data collection system.

43. The system of claim 24 comprising an ENUM database for providing ENUM information to the national surveillance database, the ENUM information including at least one additional subscriber identifier corresponding to a subscriber ID in the communication-related information, wherein the ENUM information is included in the communication-related information received at the communication node.

44. The system of claim 24 wherein the surveillance database function is adapted to query an ENUM database for ENUM information including at least one additional subscriber identifier corresponding to a subscriber ID in the communication-related information and receive the ENUM information, and the surveillance screening function is adapted to use the received ENUM information to screen signaling messages relating to communications associated with the individuals.

45. The system of claim 44 wherein the ENUM information includes naming authority pointer (NAPTR) information.
